(19) United States
(12) Patent Application Publication
(10) Pub. No.: US 2026/0200278 A1
(43) Pub. Date: Jul. 16, 2026

(54) VEHICLE CONTROL SYSTEM

(71) Applicant: TOYOTA JIDOSHA KABUSHIKI KAISHA, Toyota-shi (JP)

(72) Inventor: Hiroki FURUTA, Toki-shi (JP)

(73) Assignee: TOYOTA JIDOSHA KABUSHIKI KAISHA, Toyota-shi (JP)

(21) Appl. No.: 19/350,412

(22) Filed: Oct. 6, 2025

(30) Foreign Application Priority Data
Jan. 16, 2025 (JP) 2025-006356

(51) Int. Cl. B60G 17/0165

(52) U.S. Cl. CPC B60G 17/0165; B60G 2400/252; B60G 2800/916

(57) ABSTRACT

The vehicle includes an actuator that applies a vertical control force to the suspension of the wheel. The vehicle control system performs damping control to control the actuator to suppress vibration of the sprung structure on the wheels. The damping control includes rear preview control. The rear preview gain is a gain of the rear preview control. The vehicle control system sets the rear preview gain when the vehicle speed is the first speed lower than the rear preview gain when the vehicle speed is the second speed higher than the first speed.

### CROSS-REFERENCE TO RELATED APPLICATION

This application claims priority to Japanese Patent Application No. 2025-006356 filed on Jan. 16, 2025. The disclosure of the above-identified application, including the specification, drawings, and claims, is incorporated by reference herein in its entirety.

### BACKGROUND

### 1. Technical Field

The present disclosure relates to vibration suppression control to be applied to a vehicle.

### 2. Description of Related Art

Japanese Unexamined Patent Application Publication No. 2009-119948 (JP 2009-119948 A) discloses a suspension control device. The suspension control device includes at least one sensor that detects the behavior in the up-down direction of a front wheel-side portion of a vehicle. The suspension control device controls a suspension of a rear wheel, as a control target wheel, based on a value detected by the sensor. This control is referred to as “rear preview control”. Further, the suspension control device predicts the overlap between the road surface through which the front wheel passes and the road surface through which the rear wheel is predicted to pass when the vehicle turns. The suspension control device reduces the gain to be used for suspension control as the overlap decreases.

### SUMMARY

The “rear preview control” as a kind of vibration suppression control to be applied to a vehicle is considered. In the rear preview control, first, a front wheel up-down motion parameter related to up-down motion caused when a front wheel passes through a first position is acquired based on a measurement result from an in-vehicle sensor. Then, vibration caused when a rear wheel passes through a target position corresponding to the first position is suppressed based on the front wheel up-down motion parameter.

Here, as the vehicle speed decreases, the time since the front wheel passes through the first position until the rear wheel passes through the target position corresponding to the first position increases. Therefore, as the vehicle speed decreases, the accuracy of estimating the timing of the passage of the rear wheel may be reduced. This may lead to a reduction in the vibration suppression effect of the rear preview control.

An object of the present disclosure is to provide a technique capable of suppressing a reduction in the vibration suppression effect of rear preview control.

One aspect of the present disclosure relates to a vehicle control system to be applied to a vehicle.

The vehicle includes an actuator that applies a control force in an up-down direction to a suspension of a wheel.

The vehicle control system includes one or more processors that control the actuator to execute vibration suppression control for suppressing vibration of a sprung structure on the wheel.

The vibration suppression control includes rear preview control.

The rear preview control includes
acquiring a front wheel up-down motion parameter related to up-down motion caused when a front wheel passes through a first position based on a measurement result from a sensor mounted on the vehicle, and
controlling the actuator so as to suppress the vibration caused when a rear wheel passes through a target position corresponding to the first position based on the front wheel up-down motion parameter.

A rear preview gain is a gain of the rear preview control.

The one or more processors are configured to set the rear preview gain at a time when a speed of the vehicle is a first speed to be lower than the rear preview gain at a time when the speed is a second speed higher than the first speed.

According to the present disclosure, the rear preview gain at a low speed is set to be lower than the rear preview gain at a high speed. This suppresses a reduction in the vibration suppression effect of the rear preview control at a low speed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1A is a conceptual diagram illustrating a configuration example of a vehicle and a suspension;

FIG. 1B is a conceptual diagram illustrating a configuration example of a vehicle and a suspension;

FIG. 2 is a conceptual diagram for explaining rear preview control;

FIG. 3A is a conceptual diagram illustrating an exemplary setting of a rear preview gain;

FIG. 3B is a conceptual diagram illustrating an exemplary setting of a rear preview gain;

FIG. 3C is a conceptual diagram illustrating an exemplary setting of a rear preview gain;

FIG. 4 is a conceptual diagram for explaining the setting of the total gain of the vibration suppression control;

FIG. 5A is a conceptual diagram for describing an exemplary setting of the rear preview gain and the feedback gain;

FIG. 5B is a conceptual diagram for describing an exemplary setting of the rear preview gain and the feedback gain;

FIG. 5C is a conceptual diagram for describing an exemplary setting of the rear preview gain and the feedback gain;

FIG. 6A is a conceptual diagrams for explaining still another exemplary setting of the rear preview gain and the feedback gain; and

FIG. 6B is a conceptual diagram for explaining still another exemplary setting of the rear preview gain and the feedback gain.

### DETAILED DESCRIPTION OF EMBODIMENTS

Embodiments of the present disclosure will be described with reference to the accompanying drawings.

### 1. Vehicle Control System

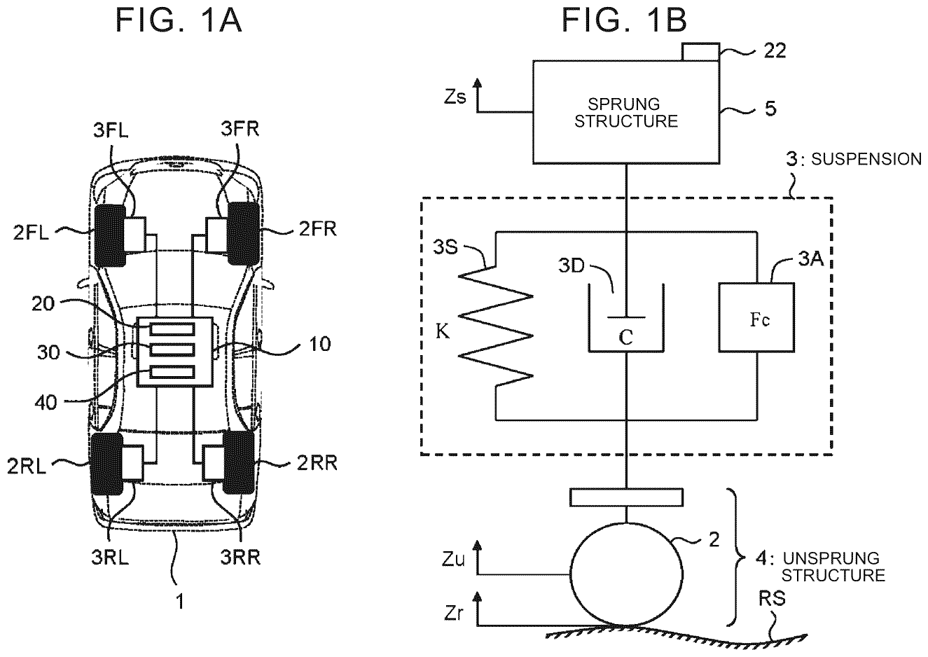

FIGS. 1A and 1B are schematic diagrams illustrating a configuration example of a vehicle 1 and a suspension 3 according to the present embodiment. The vehicle 1 includes wheels 2 and a suspension 3. The wheel 2 includes a left front wheel 2FL, a right front wheel 2FR, a left rear wheel 2RL, and a right rear wheel 2RR. Suspension 3FL, 3FR, 3RL and 3RR are provided for each of the left front wheel 2FL, the right front wheel 2FR, the left rear wheel 2RL, and the right rear wheel 2RR. In the following description, each wheel is referred to as a wheel 2, and each suspension is referred to as a suspension 3, particularly when there is no need for distinction.

The suspension 3 is provided to connect between the unsprung structure 4 and the sprung structure 5 of the vehicle 1. The unsprung structure 4 includes wheels 2. The suspension 3 includes a spring 3S, a damper (shock absorber) 3D, and an actuator 3A. The spring 3S, the damper 3D, and the actuator 3A are provided in parallel between the unsprung structure 4 and the sprung structure 5. The spring rate of the spring 3S is K. The damping factor of the damper 3D is C. The damping force of the damper 3D may be variable. The actuator 3A applies a vertical control force Fc between the unsprung structure 4 and the sprung structure 5.

Here, the term is defined. The “road surface displacement Zr” is a vertical displacement of the road surface RS. The “unsprung displacement Zu” is the vertical displacement of the unsprung structure 4. The “sprung displacement Zs” is a vertical displacement of the sprung structure 5. The “unsprung speed Zu′” is the vertical speed of the unsprung structure 4. The “sprung speed Zs” is the vertical speed of the sprung structure 5. The “unsprung acceleration Zu” is the vertical acceleration of the unsprung structure 4. The “sprung acceleration Zs” is the vertical acceleration of the sprung structure 5. Note that the sign of each parameter is positive in the case of the upward direction and negative in the case of the downward direction.

The wheels 2 move on the road surface RS. In the following explanation, a parameter related to the up-down motion (vertical motion) of the wheel 2 is referred to as an “up-and-down movement parameter”. Examples of the up-down motion parameter include the road surface displacement Zr, the unsprung displacement Zu, the unsprung velocity Zu′, the unsprung acceleration Zu “, the sprung displacement Zs, the sprung velocity Zs′, and the sprung acceleration Zs”. The up-down motion parameter may also be referred to as a “road surface displacement related parameter” associated with the road surface displacement Zr.

The vehicle control system 10 is applied to the vehicle 1 and controls the vehicle 1. For example, the vehicle control system 10 is mounted on the vehicle 1. As another example, the vehicle control system 10 may be distributed between the vehicle 1 and a remote device.

The vehicle control system 10 includes a sensor 20 mounted on the vehicle 1. The sensor 20 includes a vehicle speed sensor (wheel speed sensor) that detects the vehicle speed V of the vehicle 1, a sprung acceleration sensor that detects the sprung acceleration Zs″, and the like. The sensor 20 may include a stroke sensor that detects a stroke ST (=Zs−Zu) that is a relative displacement between the sprung structure 5 and the unsprung structure 4. The sensor 20 may include an unsprung acceleration sensor. In addition, the sensor 20 may include a lateral acceleration sensor, a yaw rate sensor, a steering angle sensor, and the like.

Further, the vehicle control system 10 includes one or more processors 30 (hereinafter, simply referred to as “processors 30”) and one or more storage devices 40 (hereinafter, simply referred to as “storage devices 40”). The processor 30 executes various processes. For example, the processor 30 includes a CPU (Central Processing Unit). The processor 30 may also be referred to as processing circuitry. The storage device 40 stores various types of information. Examples of the storage device 40 include volatile memory, non-volatile memory, HDD (Hard Disk Drive), SSD (Solid State Drive), and the like. The function of the vehicle control system 10 may be realized by the processor 30 executing the vehicle control program. The vehicle control program may be recorded in a computer-readable recording medium.

The vehicle control system 10 (processor 30) controls the suspension 3. Typically, the vehicle control system 10 (processor 30) controls the suspension 3 to perform vibration suppression control for suppressing vibration of the sprung structure 5 of the vehicle 1 (target vehicle). For example, the vehicle control system 10 (processor 30) controls the actuator 3A to generate a vertical control force Fc between the unsprung structure 4 and the sprung structure 5, thereby suppressing vibrations of the sprung structure 5. Such damping control will be described in more detail below.

### 2. Vibration Suppression Control

For example, in the following explanation, a case where the up-down motion parameter is the unsprung displacement Zu will be considered. In the case of generalization, “unsprung displacement” in the following description is read as “up-down motion parameter”.

The vehicle control system 10 calculates the unsprung displacement Zu based on the measurement by the sensor 20 mounted on the vehicle 1. This process is hereinafter referred to as “unsprung displacement calculation process”.

More specifically, first, the sprung acceleration Zs″ is detected by a sprung acceleration sensor installed in the sprung structure 5. Subsequently, the sprung displacement Zs is calculated by integrating the sprung acceleration Zs″ on the second floor. Subsequently, a stroke ST (=Zs−Zu) is obtained, which is the relative displacement between the sprung structure 5 and the unsprung structure 4. For example, the stroke ST is detected by a stroke sensor installed in the suspension 3. As another example, the stroke ST may be estimated based on the sprung acceleration Zs″ by an observer configured based on a single-wheel two-degree-of-freedom model. In order to suppress the effect of the sensor drift or the like, the time-series data of the sprung displacement Zs and the time-series data of the stroke ST may be filtered. For example, the filter is a band-pass filter that passes signal components in a specific frequency band. The specific frequency band may be set to include the sprung resonance frequency of the vehicle 1. For example, the specified frequency band is 0.3-10 Hz. Then, the difference between the sprung displacement Zs and the stroke ST is calculated as the sprung displacement Zu. Alternatively, the unsprung acceleration Zu″ may be detected by the unsprung acceleration sensor, and the unsprung displacement Zu may be calculated from the unsprung acceleration Zu ″.

The equation of motion for the sprung structure 5 is represented by the following equation (1).

$$m \cdot {Zs}^{″} = C ( {Zu}^{′} - {Zs}^{′} ) + K ( Zu - Zs ) - Fc \qquad ( 1 )$$

In Expression (1), m is the mass of the sprung structure 5, C is the damping factor of the damper 3D, K is the spring constant of the spring 3S, and Fc is the vertical control force Fc generated by the actuator 3A. When the control force Fc completely cancels the oscillation of the sprung structure 5 (Zs″=0, Zs'=0, Zs=0), the control force Fc is expressed by the following equation (2).

$$Fc = C \cdot {Zu}^{′} + K \cdot Zu \qquad ( 2 )$$

The control force Fc providing at least the damping effect is expressed by the following equation (3).

$$Fc = α \cdot C \cdot {Zu}^{′} + β \cdot K \cdot Zu \qquad ( 3 )$$

In Expression (3), the gain α is greater than 0 and less than or equal to 1, and the gain β is also greater than 0 and less than or equal to 1. When the differential term in Equation (3) is omitted, the control force Fc that provides at least the damping effect is expressed by the following Equation (4).

$$Fc = β \cdot K \cdot Zu \qquad ( 4 )$$

The vehicle control system 10 calculates the target control force Fc according to Equation (3) or Equation (4). Then, the vehicle control system 10 controls the actuator 3A so as to generate the target control force Fc.

### 3. Rear Preview Control

### 3-1. Overview

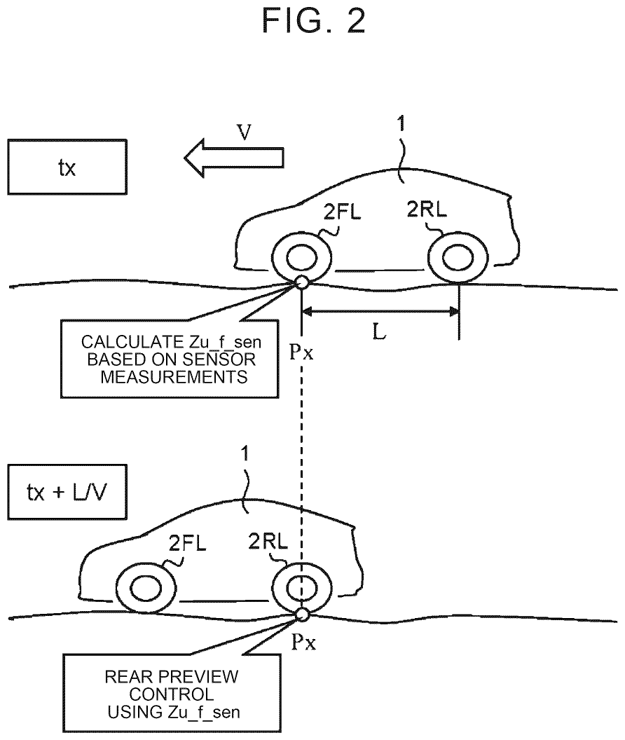

FIG. 2 is a conceptual diagram for explaining “rear preview control” which is an example of vibration suppression control. Here, the combination of the left front wheel 2FL and the left rear wheel 2RL will be described, but the same applies to the combination of the right front wheel 2FR and the right rear wheel 2RR. First, in the timing tx in which the left front wheel 2FL passes through the first position Px, the unsprung displacement Zu_sen is calculated in real time by the unsprung displacement calculation process. This unsprung displacement Zu_sen is referred to as a front wheel unsprung displacement Zu_f_sen for convenience.

After the elapse of the time L/V from the timing tx, the left rear wheel 2RL (target wheel) passes through the target position corresponding to the first position Px. Here, L is a wheel base between the left front wheel 2FL and the left rear wheel 2RL, and V is a vehicle speed of the vehicle 1. The vehicle speed V is detected by the sensor 20. Ideally, the target position coincides with the first position Px. However, there is a possibility that the target position is slightly deviated from the first position Px due to an error of the vehicle speed V or the like. In the timing tx+L/V, the vibration suppression control for the left rear wheel 2RL is performed using the front wheel unsprung displacement Zu_f_sen calculated above. The target control force Fc at this time is expressed by, for example, the following Expression (5).

$$Fc = Grp \cdot Zu\_f \_sen \qquad ( 5 )$$

In Expression (5), the rear preview gain Grp is the gain of the rear preview control, and corresponds to “β·K” in Expression (4). β takes a value of 0-1. K is the vertical spring rate of the spring 3S of the suspension of the target wheel of the vehicle 1.

The vehicle control system 10 controls the actuator 3A to generate the target control force Fc at the timing tx+L/V. This suppresses vibrations when the left rear wheel 2RL (target wheel) passes through the target position.

### 3-2. Gain Setting Considering Vehicle Speed

The lower the vehicle speed V, the longer the time from when the front wheel passes through the first position until when the rear wheel passes through the target position corresponding to the first position. Therefore, the lower the vehicle speed V is, the lower the estimation accuracy of the passing timing of the rear wheels may be. This may lead to a reduction in the damping effect by the rear preview control. Therefore, according to the present embodiment, the rear preview gain Grp is appropriately set in view of the vehicle speed V.

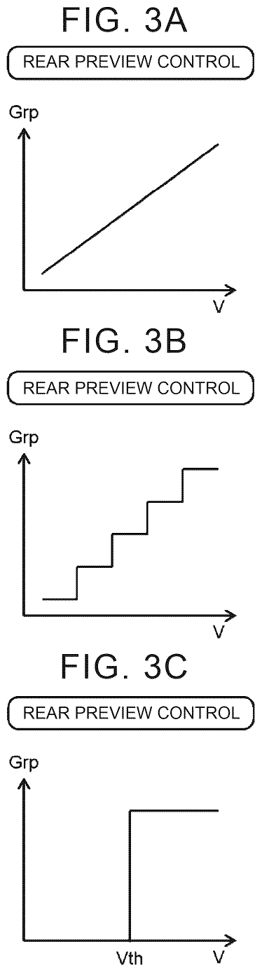

FIGS. 3A to 3C are conceptual diagrams for describing various exemplary gain settings considering the vehicle speed V. The horizontal axis represents the vehicle speed V, and the vertical axis represents the rear preview gain Grp. In FIG. 3A, as the vehicle speed V decreases, the rear preview gain Grp monotonically decreases. In FIG. 3B, as the vehicle speed V decreases, the rear preview gain Grp gradually decreases. In FIG. 3C, the rear preview control is executed when the vehicle speed V is equal to or higher than the threshold Vth, and the rear preview control is not executed when the vehicle speed V is lower than the threshold Vth (rear preview gain Grp=0).

Generalization is as follows: The second vehicle speed V2 is higher than the first vehicle speed V1 (V2>V1). The vehicle control system 10 sets the rear preview gain Grp in the first vehicle speed V1 to be lower than the rear preview gain Grp in the second vehicle speed V2. This suppresses a decrease in the damping effect caused by the rear preview control at a low speed. Conversely, the vehicle control system 10 sets the rear preview gain Grp in the second vehicle speed V2 higher than the rear preview gain Grp in the first vehicle speed V1. This makes it possible to effectively perform rear preview control at high speed.

### 3-3. Gain Setting Considering Deviation

In addition to the vehicle speed V, the degree of deviation between the trajectory of the front wheel and the trajectory of the rear wheel may be taken into consideration. The degree of deviation between the trajectory of the front wheel and the trajectory of the rear wheel can be calculated by, for example, the method described in Japanese Unexamined Patent Application Publication No. 2009-119948 (JP 2009-119948 A). The vehicle control system 10 acquires the degree of deviation between the trajectory of the front wheel and the trajectory of the rear wheel based on the measurement result (the vehicle speed V, the steering angle, and the like) by the sensor 20 mounted on the vehicle 1. When the degree of deviation increases, there is a possibility that the damping effect by the rear preview control may be lowered. Therefore, the vehicle control system 10 may set the rear preview gain Grp in accordance with the degree of deviation. More specifically, the vehicle control system 10 sets the rear preview gain Grp in a case where the deviation degree is the first level lower than the rear preview gain Grp in a case where the deviation degree is the second level lower than the first level. As a result, when the degree of deviation is high, it is possible to suppress a decrease in the damping effect caused by the rear preview control.

### 4. Combination of Rear Preview Control and Feedback Control

### 4-1. Overview

The damping control according to the present embodiment may include both rear preview control and feedback control. That is, the damping control according to the present embodiment may be a combination of rear preview control and feedback control.

For example, the feedback control is an unsprung feedback control that suppresses vibration based on the unsprung displacement Zu_sen. The unsprung displacement Zu_sen is calculated in real time by the unsprung displacement calculation process described above based on the measurement result by the sensor 20 mounted on the vehicle 1. The unsprung displacement Zu_sen when the rear wheel passes through the target position is referred to as the rear wheel unsprung displacement Zu_r_sen for convenience. The target control force Fc is expressed by the following equation (6), for example.

$$Fc = Gfb \cdot Zu\_r \_sen + Grp \cdot Zu\_f \_sen \cdot {e}^{- τ s} \qquad ( 6 )$$

The first term on the right side of Equation (6) represents the control force by unsprung feedback control. The feedback gain Gfb is the gain of the unsprung feedback control. The second term on the right side of Equation (6) represents the control force by the rear preview control. The rear preview gain Grp is a gain of the rear preview control. e^{-ts} represents a time delay calculated from the wheel base L and the vehicle speed V. The feedback gain Gfb represents the contribution of the feedback control to the entire damping control, and the rear preview gain Grp represents the contribution of the rear preview control to the entire damping control.

Due to the effects of the integration error and the filtering process, the control performance of the feedback control is not as high as the rear preview control. However, even when the vehicle speed V is low, the damping effect by the feedback control is not reduced, and a certain damping effect can be reliably obtained. Therefore, by combining the rear preview control and the feedback control, it is possible to obtain a control effect at all times, and it is possible to achieve both high control performance and reliability.

### 4-2. Total Gain Setting

The total gain Gt is the sum of the rear preview gain Grp for the rear preview control and the feedback gain Gfb for the feedback control (Gt=Grp+Gfb). When the total gain Gt becomes excessively large, the vibration may be increased rather than suppressed. In order to suppress such “excitation”, the total gain Gt needs to be appropriately set.

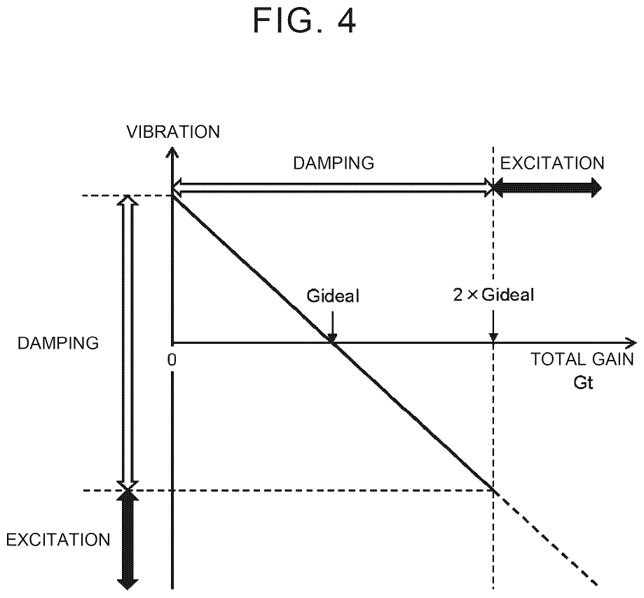

FIG. 4 is a conceptual diagram for explaining the setting of the total gain Gt of the vibration suppression control according to the present embodiment. The horizontal axis represents the total gain Gt, and the vertical axis represents the magnitude of oscillation of the sprung structure 5. The idealized gain Gideal is a total gain Gt that minimizes the oscillation of the sprung structure 5, and is determined in advance. As can be seen from the above equation (4), the idealized gain Gideal is, for example, K (Gideal=K). K is the vertical spring rate of the spring 3S of the suspension of the target wheel of the vehicle 1. The ideal gain data indicating the ideal gain Gideal is stored in advance in the storage device 40 of the vehicle control system 10.

In FIG. 4, Gt=0 corresponds to a situation in which the vibration suppression control is not performed. As the total gain Gt increases from 0, the oscillation is suppressed and decreases. When the total gain Gt is in the idealized gain Gideal, the oscillation is minimized. When the total gain Gt is larger than the ideal gain Gideal, the vibration is generated in the opposite direction to the case where the vibration suppression control is not performed. However, when the total gain Gt does not exceed twice the idealized gain Gideal, the magnitude of the vibration is smaller than that of Gt=0 even if the reverse-direction vibration occurs. In other words, when the total gain Gt does not exceed twice the idealized gain Gideal, no excitation occurs and at least the damping effect is obtained. When the total gain Gt is more than twice the idealized gain Gideal, excitation occurs.

As described above, according to the present embodiment, the total gain Gt is set to be greater than 0 and not to exceed twice the idealized gain Gideal. That is, the vehicle control system 10 sets the rear preview gain Grp and the feedback gain Gfb such that the total gain Gt is greater than 0 and does not exceed twice the ideal gain Gideal. Preferably, the vehicle control system 10 sets the rear preview gain Grp and the feedback gain Gfb so that the total gain Gt is in the vicinity of the ideal gain Gideal. Since the total gain Gt is set so as not to exceed twice the idealized gain Gideal, the damping effect can be reliably obtained without causing vibration.

### 4-3. Gain Setting Considering Vehicle Speed

The vehicle control system 10 may appropriately set the ratio between the rear preview gain Grp and the feedback gain Gfb in view of the vehicle speed V. That is, the vehicle control system 10 may flexibly adjust the contributions of the rear preview control and the feedback control in accordance with the vehicle speed V. Even when the ratio between the rear preview gain Grp and the feedback gain Gfb changes, the total gain Gt is set as described in Section 4-2 above.

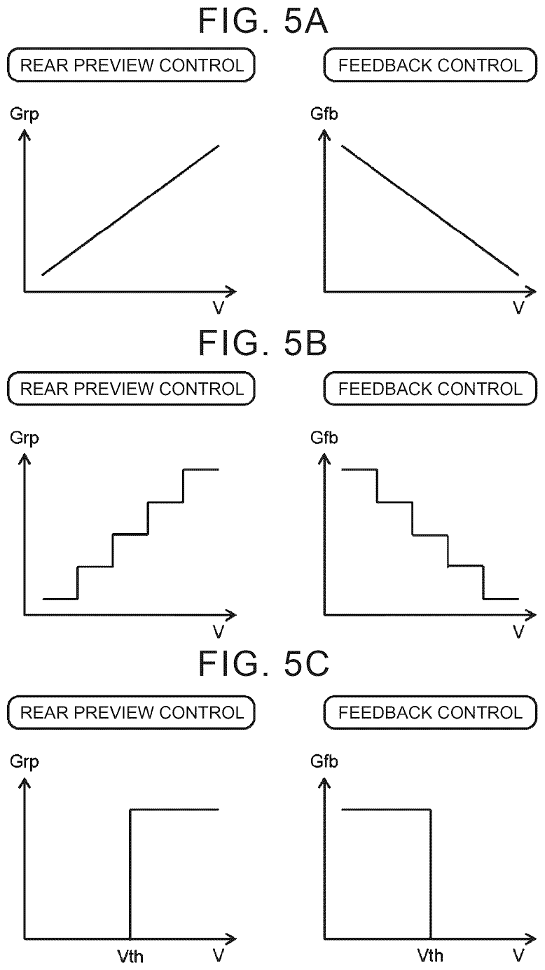

FIGS. 5A to 5C are conceptual diagrams for describing various exemplary gain settings considering the vehicle speed V. The horizontal axis represents the vehicle speed V, and the vertical axis represents the rear preview gain Grp and the feedback gain Gfb. In FIG. 5A, as the vehicle speed V decreases, the rear preview gain Grp monotonically decreases, and instead, the feedback gain Gfb monotonically increases. In FIG. 5B, as the vehicle speed V decreases, the rear preview gain Grp gradually decreases, and instead, the feedback gain Gfb monotonically increases. In FIG. 5C, the rear preview control is executed when the vehicle speed V is equal to or higher than the threshold Vth, and the feedback control is executed instead of the rear preview control when the vehicle speed V is lower than the threshold Vth.

Generalization is as follows: The second vehicle speed V2 is higher than the first vehicle speed V1 (V2>V1). The vehicle control system 10 sets the rear preview gain Grp in the first vehicle speed V1 to be lower than the rear preview gain Grp in the second vehicle speed V2. In addition, the vehicle control system 10 sets the feedback gain Gfb in the first vehicle speed V1 higher than the feedback gain Gfb in the second vehicle speed V2. This makes it possible to compensate for the effect of the damping control by the feedback control while suppressing the reduction in the damping effect by the rear preview control at a low speed. That is, it is possible to obtain a control effect at all times, and it is possible to achieve both high control performance and reliability.

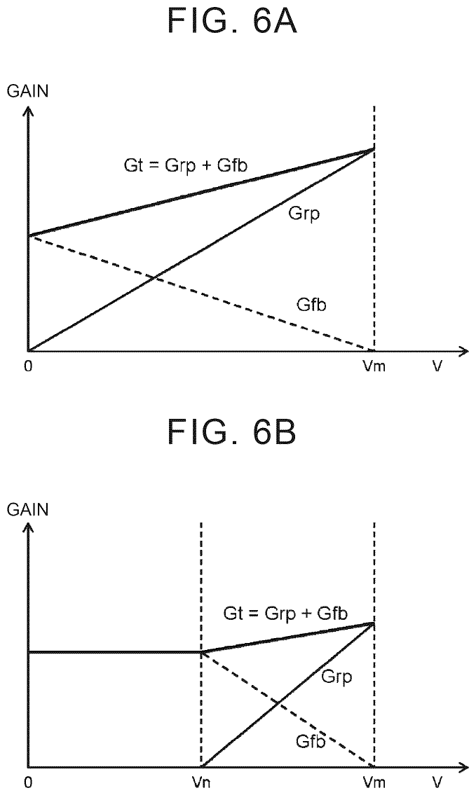

FIGS. 6A and 6B are conceptual diagrams for explaining still another exemplary gain setting considering the vehicle speed V. The horizontal axis represents the vehicle speed V, and the vertical axis represents the rear preview gain Grp, the feedback gain Gfb, and the total gain Gt.

In FIG. 6A, as the vehicle speed V decreases, the rear preview gain Grp and the total gain Gt decrease, while the feedback gain Gfb increases. For example, when the vehicle speed V is at a sufficiently high Vm, the feedback gain Gfb is set to zero and the rear preview gain Grp is set to the ideal gain Gideal. On the other hand, when the vehicle speed V is 0, the rear preview gain Grp is set to 0. The feedback gain Gfb maximum value is set to be less than the maximum value of the rear preview gain Grp. Consequently, as the vehicle speed V decreases, the total gain Gt decreases. In generalization, the total gain Gt in the case of the first vehicle speed V1 is set lower than the total gain Gt in the case of the second vehicle speed V2. Accordingly, the load and the power consumed by the actuator 3A can be reduced while ensuring a certain degree of damping effect at low speed.

In addition to the vehicle speed V, the degree of deviation between the trajectory of the front wheel and the trajectory of the rear wheel may be taken into consideration. The degree of deviation between the trajectory of the front wheel and the trajectory of the rear wheel can be calculated by, for example, the method described in JP 2009-119948 A. The vehicle control system 10 acquires the degree of deviation between the trajectory of the front wheel and the trajectory of the rear wheel based on the measurement result (the vehicle speed V, the steering angle, and the like) by the sensor 20 mounted on the vehicle 1. When the degree of deviation increases, there is a possibility that the damping effect by the rear preview control may be lowered. Therefore, the vehicle control system 10 may set the rear preview gain Grp in accordance with the degree of deviation. More specifically, the vehicle control system 10 sets the rear preview gain Grp in a case where the deviation degree is the first level lower than the rear preview gain Grp in a case where the deviation degree is the second level lower than the first level. As a result, when the degree of deviation is high, it is possible to suppress a decrease in the damping effect caused by the rear preview control.

FIG. 6B shows an exemplary gain setting when the degree of deviation is high. As compared to FIG. 6A, the rear preview gain Grp is set to be lower as a whole. Further, in the low vehicle speed range 0-Vn, the rear preview gain Grp is set to zero, and the feedback gain Gfb is set to the highest value. When the vehicle speed V exceeds Vn, the rear preview gain Grp is increased and the feedback gain Gfb is decreased. The maximum value of the feedback gain Gfb is set to be less than the maximum value of the rear preview gain Grp.

A plurality of types of gain maps may be prepared for each degree of deviation. The vehicle control system 10 performs gain setting using a gain map corresponding to the opening degree.

### 4-4. Effect

As described above, the combination of the rear preview control and the feedback control is effective. It is possible to compensate for the effect of the damping control by the feedback control while suppressing the reduction of the damping effect by the rear preview control at a low speed. It is possible to obtain a control effect at all times, and to achieve both high control performance and reliability.

What is claimed is:

1. A vehicle control system to be applied to a vehicle including an actuator that applies a control force in an up-down direction to a suspension of a wheel, the vehicle control system comprising one or more processors that control the actuator to execute vibration suppression control for suppressing vibration of a sprung structure on the wheel, wherein:
the vibration suppression control includes rear preview control;
the rear preview control includes
acquiring a front wheel up-down motion parameter related to up-down motion caused when a front wheel passes through a first position based on a measurement result from a sensor mounted on the vehicle, and
controlling the actuator so as to suppress the vibration caused when a rear wheel passes through a target position corresponding to the first position based on the front wheel up-down motion parameter;
a rear preview gain is a gain of the rear preview control; and
the one or more processors are configured to set the rear preview gain at a time when a speed of the vehicle is a first speed to be lower than the rear preview gain at a time when the speed is a second speed higher than the first speed.

2. The vehicle control system according to claim 1, wherein:
the vibration suppression control further includes feedback control;
the feedback control includes
acquiring a rear wheel up-down motion parameter related to up-down motion caused when the rear wheel passes through the target position based on a measurement result from a sensor mounted on the vehicle, and
controlling the actuator so as to suppress the vibration based on the rear wheel up-down motion parameter;
a feedback gain is a gain of the feedback control; and
the one or more processors are configured to set the feedback gain at the time when the speed is the first speed to be higher than the feedback gain at the time when the speed is the second speed.

3. The vehicle control system according to claim 2, wherein:
a total gain is a sum of the rear preview gain and the feedback gain;
an ideal gain is the total gain that minimizes the vibration of the sprung structure, and is determined in advance; and
the one or more processors are configured to set the rear preview gain and the feedback gain such that the total gain does not exceed twice the ideal gain.

4. The vehicle control system according to claim 1, wherein:
the vibration suppression control further includes feedback control;
the feedback control includes
acquiring a rear wheel up-down motion parameter related to up-down motion caused when the rear wheel passes through the target position based on a measurement result from a sensor mounted on the vehicle, and
controlling the actuator so as to suppress the vibration based on the rear wheel up-down motion parameter;
a feedback gain is a gain of the feedback control;
a total gain is a sum of the rear preview gain and the feedback gain;
an ideal gain is the total gain that minimizes the vibration of the sprung structure, and is determined in advance; and
the one or more processors are configured to set the rear preview gain and the feedback gain such that the total gain does not exceed twice the ideal gain.

5. The vehicle control system according to claim 1, wherein the one or more processors are further configured to:
acquire a degree of deviation between a trajectory of the front wheel and a trajectory of the rear wheel; and
set the rear preview gain at a time when the degree of deviation is a first level to be lower than the rear preview gain at a time when the degree of deviation is a second level lower than the first level.
